(19) United States
(12) Patent Application Publication
(10) Pub. No.: US 2019/0250060 A1
(43) Pub. Date: Aug. 15, 2019

(54) PIPELINE INSPECTION INFORMATION MANAGING DEVICE AND PIPELINE INSPECTION INFORMATION MANAGING METHOD

(71) Applicant: OLYMPUS CORPORATION, Tokyo (JP)

(72) Inventor: SUMIO KAWAI, Tokyo (JP)

(73) Assignee: OLYMPUS CORPORATION, Tokyo (JP)

(21) Appl. No.: 16/206,255

(22) Filed: Nov. 30, 2018

(30) Foreign Application Priority Data
Feb. 9, 2018 (JP) 2018-021815

(51) Int. Cl. G01M 3/00; H04N 5/225; G01S 19/47

(52) U.S. Cl. CPC G01M 3/005; H04N 5/2251; G06T 7/0004; H04N 2005/2255; G01S 19/47

(57) ABSTRACT

In order to inspect deterioration such as a crack generated in a pipeline efficiently, a pipeline inspection information managing device obtains a position where a movable body is input into a pipeline as GPS absolute position information in a positioning portion, receives movement information relating to a movement state of the movable body and inspection information obtained by the movable body in a communication portion, specifies a position of the movable body on a piping map on a basis of the GPS absolute position information and the movement information in the control portion, and generates and manages pipeline inspection information which associates a specified position on the piping map with the inspection information from the movable body for each section set on the piping map so that at least one joint portion which connects a pipe and a pipe configuring the pipeline is included.

### CROSS REFERENCE TO RELATED APPLICATION

This application claims the benefit of Japanese Application No. 2018-021815 filed in Japan on Feb. 9, 2018, the contents of which are incorporated herein by this reference.

### BACKGROUND OF THE INVENTION

### 1. Field of the Invention

The present invention relates to a pipeline inspection information managing device configured to manage pipeline inspection information obtained by an inspecting device configured to be moved inside a pipeline such as a water pipe and a gas pipe and a pipeline inspection information managing method.

### 2. Description of Related Art

With regard to pipelines such as a water pipe and a gas pipe buried in the ground or in a building, troubles caused by aging degradation, a natural disaster such as an earthquake and flood, an accident (explosion, fire and the like) are concerned about, and observation of an internal state is in demand.

Even if documents or the like about burying works regarding some of the pipelines exist, it is likely that actual pipeline positions are changed or the documents are inaccurate in some cases, and burial paths and the like are not known in some cases. Furthermore, positions where inspections are to be conducted with emphasis on such as a joint position of pipes in which a possibility of occurrence of a trouble is high and a bending position of a pipe in which a stress can easily occur are not known accurately in many cases.

Therefore, in carrying out a maintenance work for the pipelines, it is important to determine the burial site of the pipe, and grasp the state of deterioration of the pipe such as a crack, and an occurrence position of the deterioration rapidly and accurately.

In response to such demand, various proposals have recently been made on inspecting devices configured to obtain inspection data such as a movie and an image while autonomously moving inside the pipeline as a device for examining a laid state of the pipeline such as a water pipe and a gas pipe and for observing and inspecting the internal state of the pipeline.

In this case, since the pipeline such as a water pipe and a gas pipe is laid for a long distance, the pipeline inspection information based on the inspection data obtained by the inspecting device and the like is preferably managed by each of predetermined sections. Note that by carrying out position measurement by a short search pipe in each section, not only that the pipeline inspection information is organized but accuracy of the positions in the inspection data is improved even when the same measuring instrument is used.

As an art of managing information relating to a pipeline as above, Japanese Patent Application Laid-Open Publication No. 2017-49921 (Patent Literature 1) discloses an art for managing pipeline construction information (a date of manufacture, a manufacturing plant, a model, a pipe type, a nominal diameter, an effective length, a pipe shape, a work name, a date of construction, a constructor, a construction position and the like) by obtaining position information by using a GPS receiver for a joint portion of each pipe configuring a piping (pipeline) and by giving a pipe code to each pipe to be joined to the joint portion at a construction of a pipe laying work such as a water supply pipeline network, for example.

### SUMMARY OF THE INVENTION

A pipeline inspection information managing device according to an aspect of the present invention includes a GPS information obtaining portion configured to obtain a position where an inspecting device is input into a pipeline as GPS absolute position information, a receiving portion configured to receive movement information relating to a movement state of the inspecting device and inspection information of the inspecting device, a position specifying portion configured to specify a position of the inspecting device on a piping map on a basis of the GPS absolute position information and the movement information, and an information associating portion configured to generate pipeline inspection information which associates the position of the inspecting device specified by the position specifying portion on the piping map with the inspection information from the inspecting device for a section set on the piping map, and each of the sections is set to include at least one joint portion which connects a pipe and a pipe configuring the pipeline.

A pipeline inspection information management method according to an aspect of the present invention obtains a position where an inspecting device is input into a pipeline as GPS absolute position information, receives movement information relating to a movement state of the inspecting device and inspection information of the inspecting device, specifies a position of the inspecting device on a piping map on a basis of the GPS absolute position information and the movement information, and generates and manages pipeline inspection information which associates the position specified on the piping map with the inspection information from the inspecting device for each of the sections set on the piping map so that at least one joint portion which connects a pipe and a pipe configuring the pipeline is included.

### BRIEF DESCRIPTION OF THE DRAWINGS

FIG. 1 is a diagram illustrating schematic configuration of an in-pipe inspection system including an in-pipe moving device (movable body);

FIG. 2 is a block configuration diagram illustrating major configuration of the in-pipe inspection system in FIG. 1;

FIG. 3 is a view illustrating an application example of the in-pipe inspection system when an inspection of a pipeline buried under the ground or the like is carried out;

FIG. 4 is a diagram illustrating schematic configuration of a wearable device;

FIG. 5 is a flowchart illustrating a pipeline inspection information generation processing routine;

FIG. 6 is a diagram illustrating an example of a section set on a pipeline;

FIG. 7 is a diagram illustrating an example of a section newly set on the pipeline;

FIG. 8 is a diagram illustrating another example of a section newly set on the pipeline;

FIG. 9 is a diagram illustrating a display example of management information;

and

FIG. 10 is a diagram illustrating a display example of two pieces of the management information created on different time and dates.

### DETAILED DESCRIPTION OF PREFERRED EMBODIMENT

Hereinafter, the present invention will be described by referring to illustrated embodiment. Each drawing used in the following description is schematic, and in some cases a dimensional relationship, scales or the like of each member are illustrated differently for each constituent element in order to illustrate each of the constituent elements with such a size that can be recognized on drawings. Therefore, the present invention is not limited only to the illustrated forms in relation with a quantity of each of the constituent elements, a shape of each of the constituent elements, a ratio of sizes of the constituent elements, a relative positional relationship among each of the constituent elements and the like described in each drawing.

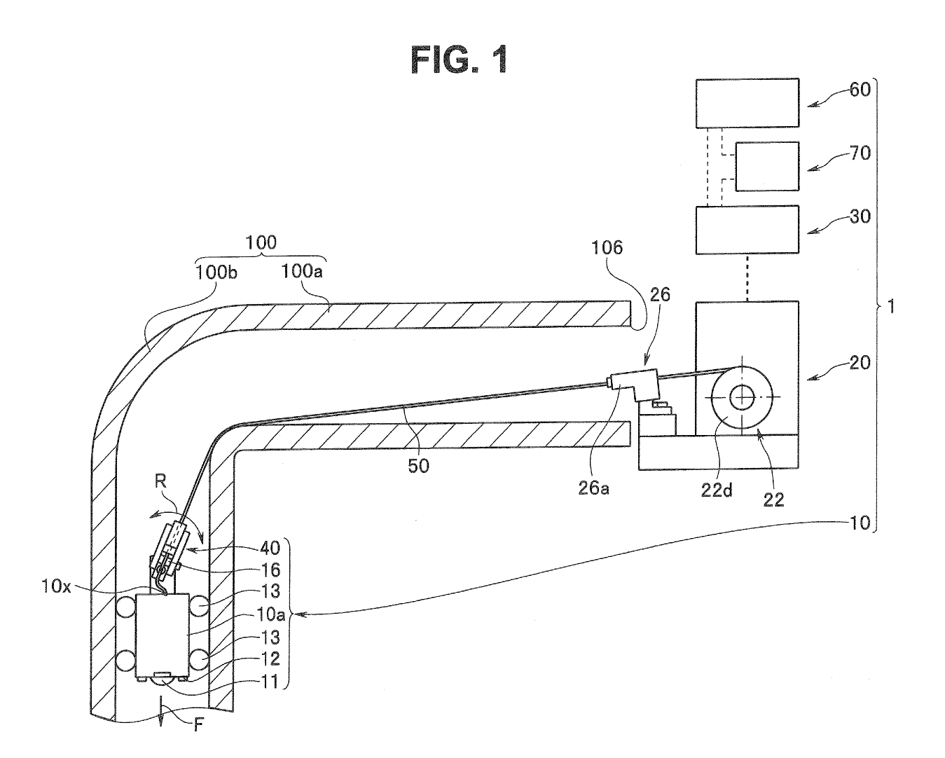

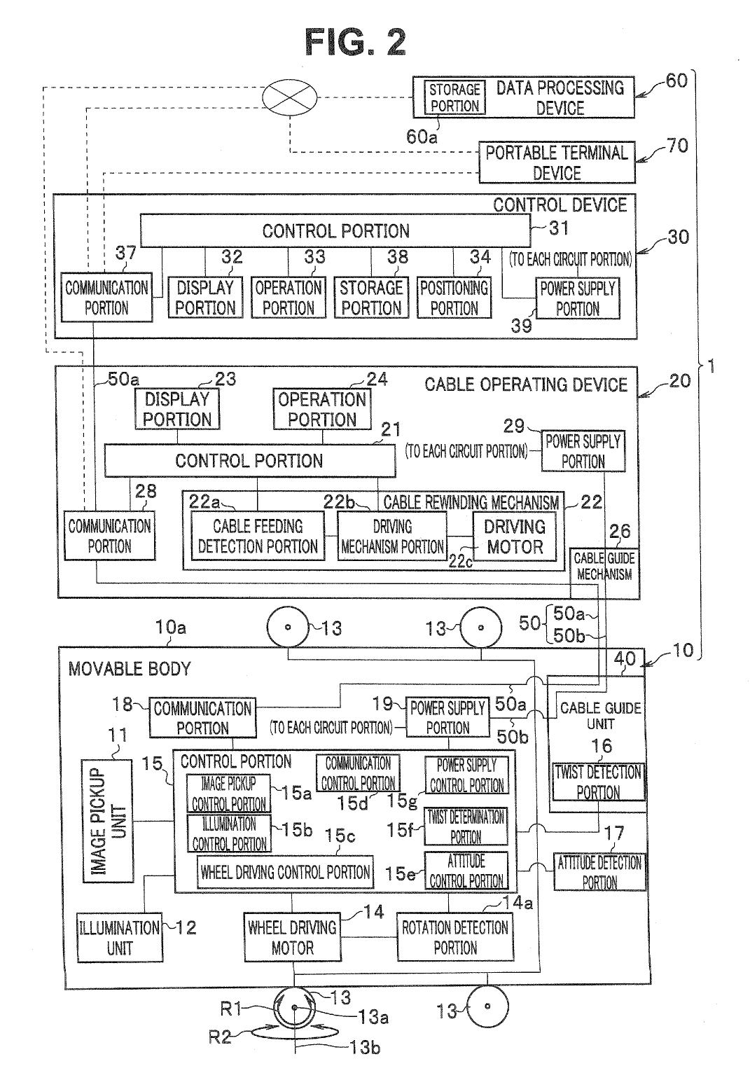

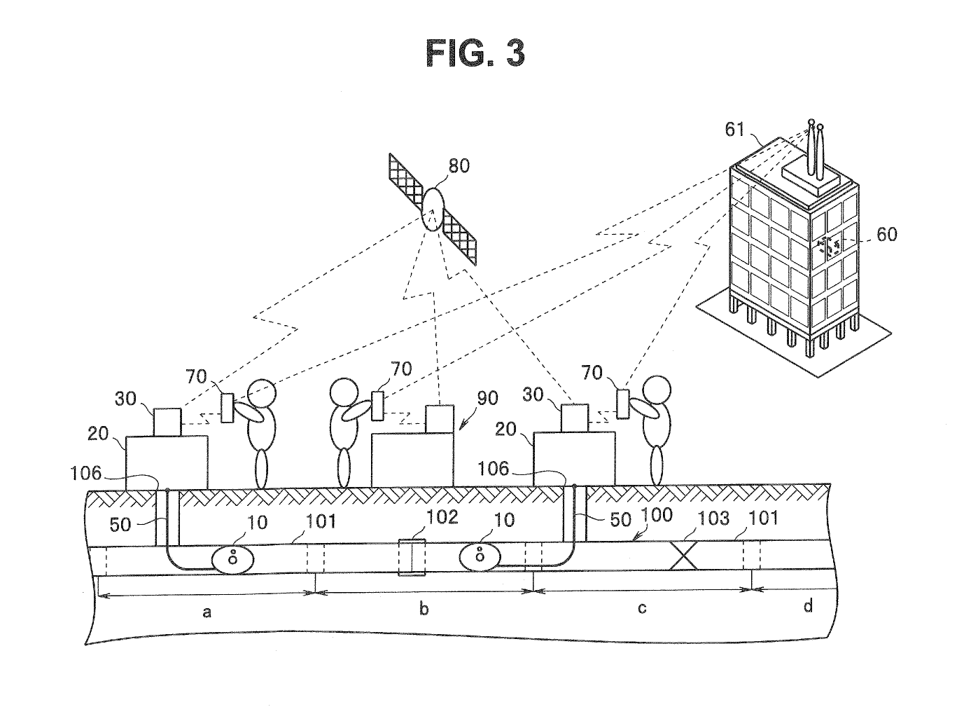

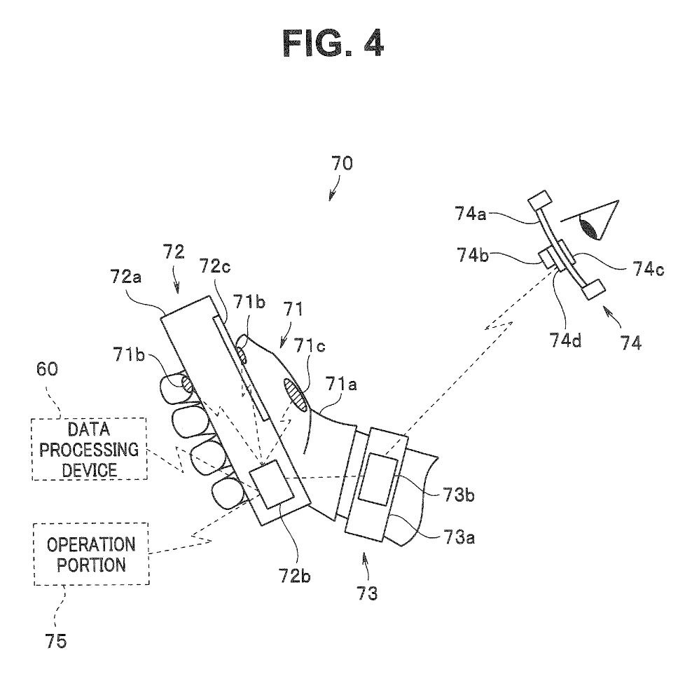

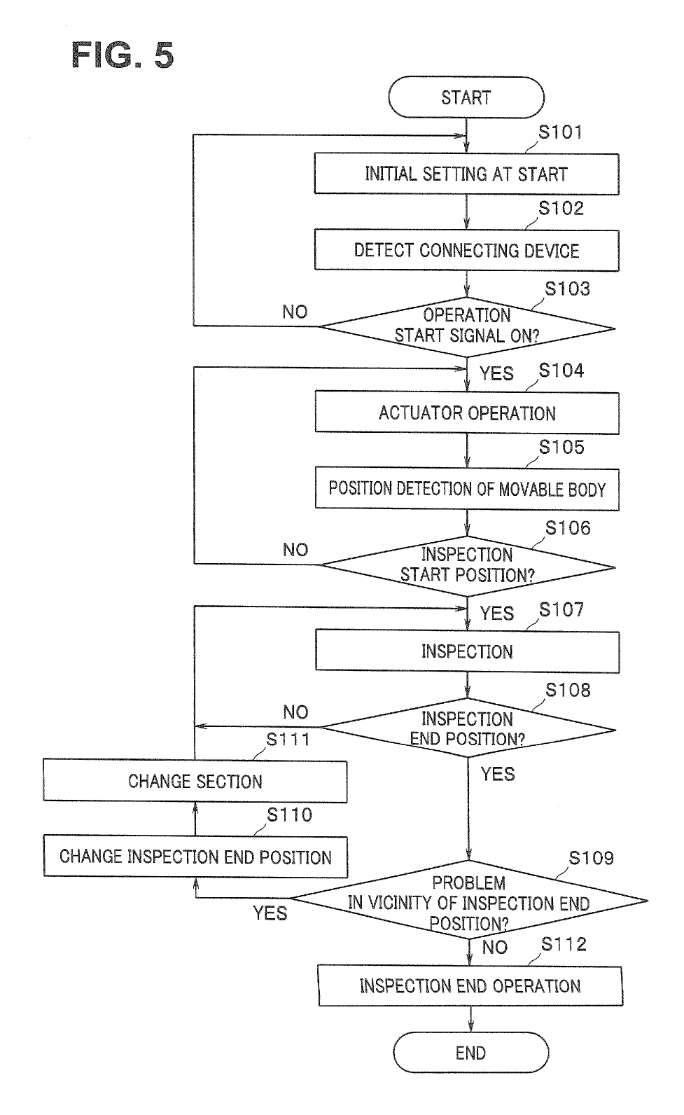

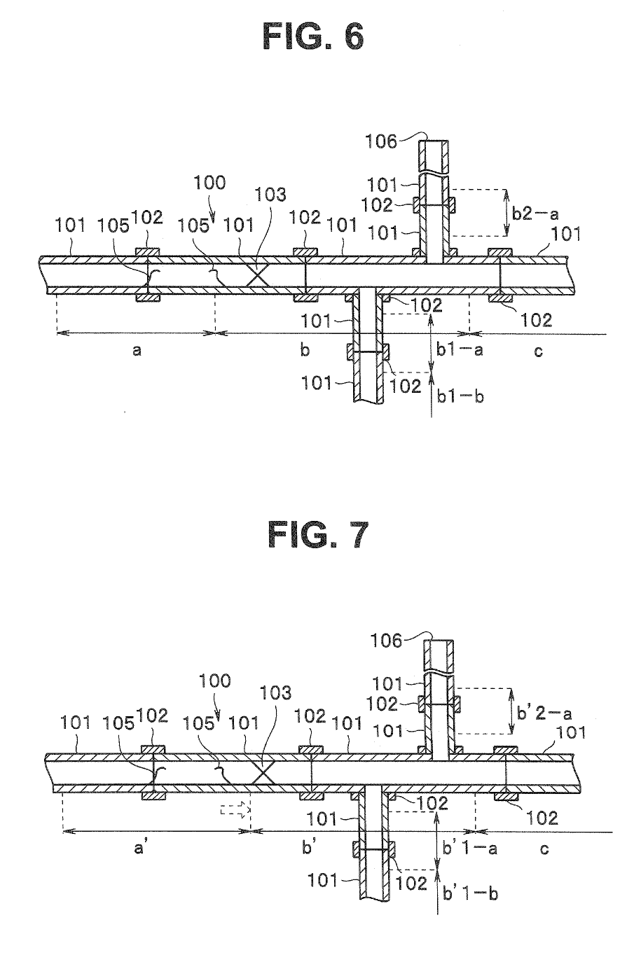

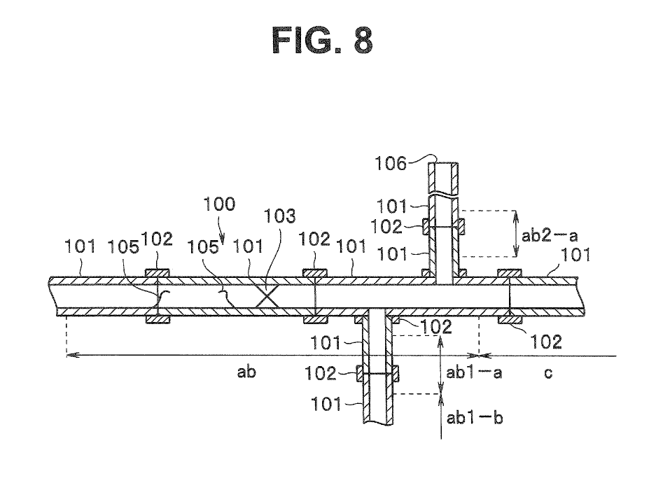

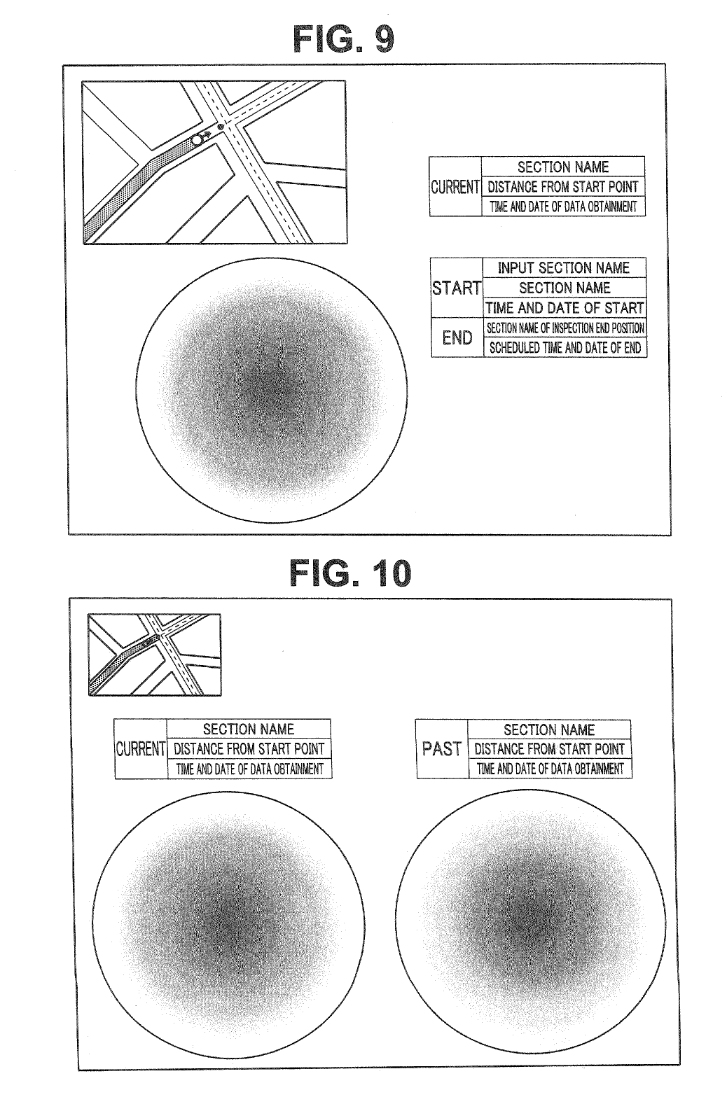

FIG. 1 is a diagram illustrating schematic configuration of an in-pipe inspection system including an in-pipe moving device (movable body) of an embodiment of the present invention. FIG. 2 is a block configuration diagram illustrating major configuration of the in-pipe inspection system in FIG. 1. FIG. 3 is a diagram illustrating an application example of the in-pipe inspection system when an inspection of a pipeline buried under the ground is carried out. FIG. 4 is a diagram illustrating schematic configuration of a wearable device. FIG. 5 is a flowchart illustrating a pipeline inspection information generation processing routine. FIG. 6 is a diagram illustrating an example of a section set on a pipeline. FIG. 7 is a diagram illustrating an example of a section newly set on the pipeline. FIG. 8 is a diagram illustrating another example of a section newly set on the pipeline. FIG. 9 is a diagram illustrating a display example of management information. FIG. 10 is a diagram illustrating a display example of two pieces of the management information created on different time and dates.

First, the configuration of the in-pipe inspection system 1 will be described below by using FIGS. 1 to 3.

The in-pipe inspection system 1 of the embodiment is an inspection system which observes and inspects a state of an inside of a pipeline 100 (see FIG. 1) having a relatively small diameter such as a water pipe and a gas pipe and examines a laid state or the like of a pipeline 100 itself, for example.

For that purpose, the in-pipe inspection system 1 is configured by having a movable body 10 as an inspecting device on which various sensors (for image obtainment, light detection, sound detection and the like) are mounted and is configured such that the movable body 10 is moved capable of advancing and retreating along an inner wall surface of the pipeline 100, and a state in the pipeline 100 can be observed and inspected by controlling the various sensors during movement of the movable body 10.

Here, an advancing direction of the movable body 10 is indicated by an arrow F in FIG. 1. An end portion closer to a front in the advancing direction F of the movable body 10 is referred to as a “front end portion”. An end portion on a side opposite to the “font end” in the advancing direction F of the movable body 10 is referred to as a “rear end portion”. And a side in the advancing direction F of the movable body 10 is referred to as a “side portion”.

As illustrated in FIGS. 1 to 3, the in-pipe inspection system 1 is configured mainly by the movable body 10 which is the in-pipe moving device (inspecting device) of the embodiment, a cable operating device 20, a control device 30, a data processing device 60, and a portable terminal device 70.

Note that as illustrated in FIG. 3, in the in-pipe inspection system 1 of the embodiment, when an inspection or the like is to be conducted in the pipeline 100, a plurality of the movable bodies 10, the cable operating devices 20, the control devices 30 and the like can be used at the same time for the data processing device 60. The data processing device 60 of the in-pipe inspection system 1 is capable of communication with a repair device 90 and the like for conducting pipeline repair as necessary.

The movable body 10 is configured mainly by a device body 10a, an image pickup unit 11, an illumination unit 12, a plurality of wheels 13, a wheel driving motor 14, a rotation detection portion 14a, a control portion 15, a twist detection portion 16, an attitude detection portion 17, a communication portion 18, a power supply portion 19, a cable 50 formed by bundling a plurality of wire materials (50a, 50b), a cable guide unit 40 (see FIG. 1) and the like.

The device body 10a is a housing incorporating various constituent units of the movable body 10 and is a basic structure of the movable body 10. Various constituent units (image pickup unit 11, the illumination unit 12, the wheel driving motor 14, the rotation detection portion 14a, the control portion 15, the attitude detection portion 17, the communication portion 18, the power supply portion 19 and the like) are accommodated and arranged inside the device body 10a.

A plurality of the wheels 13 is disposed on both side portions of the device body 10a. Note that in the movable body 10 of the embodiment, an example in which each side portion of the device body 10a is provided with two wheels 13 is illustrated.

And the other end portion of the cable 50 is connected to a rear end portion of the device body 10a. The cable guide unit 40 is disposed integrally with the device body 10a on the rear end portion of the device body 10a. In this case, the cable guide unit 40 is connected to the device body 10a so that the cable guide unit 40 can swing in an arrow R direction illustrated in FIG. 1 with respect to the device body 10a. The cable guide unit 40 is made capable of swing as above so that the cable 50 smoothly follows the device body 10a when the device body 10a is moved inside the pipeline 100.

Note that the cable guide unit 40 is configured by including the twist detection portion 16 (see FIGS. 1 and 2) configured to detect a twist of the cable 50.

The cable 50 is formed by bundling a plurality of wire materials such as a signal cable 50a for signal communication and a power supply cable 50b for power supply. One end portion of the cable 50 is fixed to a predetermined portion in the cable operating device 20 (or the control device 30), while the other end portion is fixed to a predetermined portion (a movable body fixing portion indicated by reference numeral 10x in FIG. 1) on a rear end portion of the movable body 10 (in-pipe moving device).

The cable 50 has an untwisting portion (not shown) configured to recover a state where the twist is untwisted when a twist or the like occurs. Those configured by using an elastic material such as rubber or those formed by configuring a metal wire having elasticity in a coil state or a mesh state (braided state) are applied to the untwisting portion as an outer sheath of the cable 50.

The image pickup unit 11 is an inspection information obtaining portion provided on the front end portion of the device body 10a of the movable body 10 and configured to obtain an image (still image information and movie information) on the front in the advancing direction F of the movable body 10 as the inspection information. The image pickup unit 11 is controlled by an image pickup control portion 15a (which will be described later) of the control portion 15. The image pickup unit 11 is configured by an optical portion, an image pickup portion and the like, though not shown. Here, the optical portion is a configuration unit including an image pickup optical system including a plurality of optical lenses and the like configured to form an optical image of an object (an object image). The image pickup portion is a configuration unit configured to generate an electronic image by receiving the optical image formed by the optical portion on a basis of reflection light from the object illuminated by the illumination unit 12. Note that the configuration of the image pickup unit 11 itself applied to the movable body 10 of the embodiment is similar to an image pickup unit applied to an image pickup device of a form having been practiced in general. Therefore, detailed illustration and description will be omitted.

The illumination unit 12 is an illumination portion which is a configuration unit configured to irradiate illumination light toward the front of the advancing direction F of the movable body 10. The illumination unit 12 is controlled by an illumination control portion 15b (which will be described later) of the control portion 15. The illumination unit 12 is similar to an illumination unit having a general configuration formed by a light emission source such as an LED (light emitting diode), an illumination driving circuit configured to drive the light emitting source and the like. Therefore, detailed illustration and description will be omitted.

The plurality of wheels 13 is components provided on both side portions of the device body 10a (two on each side part in the embodiment) as described above, and provided in order to smoothly more the device body 10a of the movable body 10 inside the pipeline 100.

Thus, the plurality of wheels 13 can move the movable body 10 back and forth (reciprocating movement driving) at predetermined timing as appropriate in a longitudinal axis direction (the advancing direction F) of the pipeline 100 by forward/backward rotation of an arrow R1 direction around a rotation axis 13a as illustrated in FIG. 2.

Moreover, the plurality of wheels 13 can steer the movable body 10 during the reciprocating movement in the pipeline 100 by the forward/backward rotation in an arrow R2 direction around a rotation axis 13b (steering driving) and move the movable body 10 at the predetermined timing as appropriate in a circumferential direction of the pipeline 100 (attitude change driving).

A motor for reciprocating driving and a motor for steering driving are provided on each of the plurality of wheels 13, and each of these driving motors is driven/controlled by a wheel driving control portion 15c of the control portion 15, respectively. Note that in FIG. 2, one wheel driving motor 14 is illustrated as a driving motor configured to drive the plurality of wheels 13 in order to avoid complication of the drawing.

As described above, a movement mechanism capable of linear movement and rotary movement is configured by the plurality of wheels 13, the wheel driving control portion 15c, the reciprocating driving motor, the steering driving motor (wheel driving motor 14) and the like.

Note that the reciprocating driving motor and the steering driving motor in the wheel driving motor 14 may be configured by being provided on each of the plurality of wheels 13 as described above, but as a form other than the above, one of the motors may be configured to be provided on a pair of wheels 13 (two pieces) on the front end side in the plurality of wheels 13, for example. In this case, the pair of the wheels 13 on the rear end is driven wheels rotated without receiving a driving force from the reciprocating driving motor. Furthermore, one reciprocating driving motor and one steering driving motor can be configured to be provided in the movable body 10. The case can be handled by providing a mechanism configured to divide and to transmit the driving force of each of the driving motors to each of the wheels 13.

The pipeline 100 through which the movable body 10 is moved is not formed only by a linear portion 100a, but by a bent portion 100b or the like which is bent by a predetermined angle with respect to the advancing direction F, for example, as shown in FIG. 1.

Thus, in the bent portion as above, a predetermined steering mechanism (not shown) is provided in the movable body 10 of the embodiment in order to smoothly move the movable body 10. The steering mechanism acts upon receipt of the driving force of the steering driving motor configured to rotate the plurality of wheels 13 in the arrow R2 direction in FIG. 2.

Note that the plurality of wheels 13 can be rotated in the arrow R2 direction in FIG. 2 by the steering mechanism, and the rotation of the plurality of wheels 13 in that case is configured so that the rotation can be made up to a position where an angle of approximately 90 degrees is made with respect to the advancing direction F.

Then, when the plurality of wheels 13 is brought into the state described above, by rotating the plurality of wheels 13 in the arrow R1 direction in FIG. 2, the movable body 10 can be rotated in the circumferential direction in the pipeline 100. As a result, an attitude of the movable body 10 in the circumferential direction in the pipe can be adjusted.

The plurality of wheels 13 is configured to be given a biasing force toward both inner wall surfaces of the pipeline 100 faced with both side surfaces of the device body 10a in the movable body 10 when the movable body 10 is inserted into the pipeline 100.

In this case, as the biasing force, a biasing force of a biasing member such as a coil spring is used, for example (illustration and description of specific configuration of the biasing member are omitted). The plurality of wheels 13 is biased toward the inner wall surfaces (sidewall surfaces) of the pipeline 100 by the biasing force. Therefore, since the plurality of wheels 13 is pressed toward both inner wall surfaces of the pipeline 100 at all times, the movable body 10 maintains a predetermined attitude inside the pipeline 100.

In the configurations around the plurality of wheels 13, the reciprocating driving mechanism and the steering driving mechanism, for example, are both controlled by the control portion 15. Note that since the other configurations around the plurality of wheels 13 is a portion not directly related to the present invention, the description and illustration are omitted.

The wheel driving motor 14 is a power source which causes the plurality of wheels 13 to be driven and the reciprocating driving and the steering driving of the movable body 10 to be carried out as described above.

With regard to the wheel driving motor 14, a rotation number is detected by the rotation detection portion 14a. The detection result is transmitted to the wheel driving control portion 15c of the control portion 15 and contributes to driving control of the wheel driving motor 14 when a moving speed or a steering angle of the movable body is adjusted, for example.

A photo interrupter in a general form including a transmissive photo-sensor and a light shielding blade and the like is employed for the rotation detection portion 14a. The transmissive photo-sensor is a sensor member formed by arranging a light emitting element and a light receiving element in a face-to-face manner. The light shielding blade is provided coaxially with the wheel driving motor 14 or the rotation axis of the wheel, for example, and is a rotary blade member configured to be rotated in the same direction with the rotation of the wheel driving motor 14 or the wheel 13. The light shielding blade is formed having a plurality of blade portions which intermittently shield light between the light emitting element and the light receiving element of the transmissive photo-sensor with rotation. The rotation detection portion 14a detects the rotation number of the wheel 13 by the configuration as above.

Since a moving distance of the movable body 10 is calculated from the rotation number of the wheel 13 and a diameter of the wheel 13 and a moving direction is known from the attitude detection portion 17, a relative position of the movable body 10 having an input position of the movable body 10 into the pipe as a start point is known. Since the input position can be obtained as a map position from GPS position information of the pipe which will be described later, a position of the movable body 10 on the map is known accurately. By comparing a working diagram of the pipe with the aforementioned position on the map, a positional shift of the piping can also be inspected. On the other hand, by detecting a position of the joint portion by an image picked up by the movable body 10 and by setting the start point at the joint portion of the pipe, a separation position of a section of the inspection which will be described later can be detected more accurately.

The control portion 15 is configured by a control circuit and the like configured to integrally control an entirety of the movable body 10 of the embodiment. The control portion 15 is configured mainly by having the image pickup control portion 15a, the illumination control portion 15b, the wheel driving control portion 15c, a communication control portion 15d, an attitude control portion 15e, a twist determination portion 15f, a power supply control portion 15g and the like. Note that the control portion 15 is configured by having various circuit portions and the like other than the above, but since the circuit portions and the like, not shown, are portions not directly related to the present invention, the illustration and description are omitted.

The image pickup control portion 15a is a control circuit portion configured to control the image pickup unit 11. The illumination control portion 15b is a control circuit portion configured to control the illumination unit 12. The wheel driving control portion 15c is a control circuit portion configured to control the wheel driving motor 14. In this case, the wheel driving control portion 15c executes driving control of the wheel driving motor 14 upon receipt of an output of the rotation detection portion 14a. The communication control portion 15d is a control circuit portion configured to control the communication portion 18. The power supply control portion 15g is a control circuit portion configured to control the power supply portion 19.

The attitude control portion 15e is a circuit portion configured to control the attitude of the movable body 10 which is moving inside the pipeline 100. More specifically, the attitude control portion 15e controls the attitude and the position of the movable body 10 in order to move the movable body 10 reliably and smoothly on a basis of an output from the attitude detection portion 17, various sensor outputs, and image information obtained by the image pickup unit 11 and the like. Thus, the attitude control portion 15e adjusts the attitude of the movable body 10 by controlling a rotation amount of the wheel driving motor 14 so that the reciprocating movement, the steering angle and the like of the movable body 10 are controlled.

The attitude control portion 15e also executes attitude control which modifies and solves a twisted state of the cable 50 generated during movement of the movable body 10 in the pipeline 100.

In other words, the twist determination portion 15f determines the twisted state of the cable 50 such as a twist amount, a twist direction and the like on a basis of an output from the twist detection portion 16, and the attitude control portion 15e controls the attitude of the device body 10a so that the twist amount of the cable 50 does not exceed a predetermined allowable amount, for example, on a basis of a judgement result.

The twist determination portion 15f is a circuit portion configured to determine the twisted state of the cable 50 on a basis of the output of the twist detection portion 16. The judgement result is outputted to the attitude control portion 15e. Upon receiving the output, the attitude control portion 15e executes the attitude control which modifies and solves the twisted state of the cable 50.

That is, the attitude control portion 15e executes control which untwists the twist of the cable 50 by controlling the movement mechanism configured by the plurality of wheels 13, the reciprocating driving motor, the steering driving motor and the like so that the device body 10a of the movable body 10 is rotated/controlled in a direction opposite to the twist direction of the cable 50. Since sagging or tangling problem of the cable 50 can be solved by untwisting the cable 50, detection accuracy can be improved by detecting a moving distance of the movable body 10 with a feeding amount of the cable 50.

The communication portion 18 is a configuration unit including a function of conducting communication with the cable operating device 20, the control device 30 and the like which are external devices provided separately from the movable body 10. The communication portion 18 is controlled by the communication control portion 15d of the control portion 15. As a result, the communication portion 18 conducts transmission/reception of various signals such as reception of a predetermined control signal from the external devices through the signal cable 50a included in the cable 50, transfer of various types of data such as image data obtained by the image pickup unit 11 to the external devices, transmission of the various sensor outputs to the external devices and the like.

Various forms of communication such as wireless communication or wired communication can be applied as a form of the communication portion 18. In the movable body 10 of the embodiment, the form in which the wired communication using the signal cable 50a included in the cable 50 is conducted is exemplified.

Note that the configuration of the communication portion 18 only needs to include a communication function conducted between conventional electronic instruments, and since those having been practiced in general can be applied, detailed description and illustration are omitted.

The power supply portion 19 is a configuration unit configured to supply electricity to the entire movable body 10. The power supply portion 19 is controlled by the power supply control portion 15g of the control portion 15. A charging type battery or the like is applied for the power supply portion 19 and in addition, power supply from an external power source is received through the power supply cable 50b included in the cable 50 so that power is supplied to each circuit portion of each unit in the movable body 10 as necessary.

The twist detection portion 16 is a detecting means configured to detect a twist of the cable 50. The detection result is outputted to the twist determination portion 15f of the control portion 15. A rotary encoder or the like is applied as a form of the twist detection portion 16.

Note that a form of the twist detection portion 16 may be a form of optical detection or may be a form of electric detection. As the optical detection type form, various forms such as the one including a zebra-pattern scale and a photo-reflector (PR), the one including an arrow-shaped scale and a photo-interrupter (PI), the one including a moire fringe or interference fringe scale and a photo-sensor and the like can be applied. As the electric detection type form, various forms such as the one in which the scale is configured by a magnet, and a sensor is made of a magnetic resistance element using a GMR (giant magneto resistive effect) or a hall element using a Hall effect, the one which detects a change in electrostatic capacity between fan-shaped counter electrodes (using a principle of variable capacitor), the one having on-off switch configuration including a gray-code electrode pattern and a sliding armature, the one in a form in which a change in an electric resistance value is detected by a sliding armature sliding on an electrode pattern of a resistor can be applied.

Here, the twist of the cable 50 is a phenomenon generated by an attitude change of the movable body 10 which is moving in the pipeline 100. That is, the cable 50 has one end portion fixed to the predetermined portion of the cable operating device 20 (or the control device 30) and the other end portion fixed to the predetermined portion (the movable body fixing portion 10x) on the rear end portion of the movable body 10. As a result, the other end portion of the cable 50 is connected to the movable body 10. Therefore, during movement of the movable body 10 inside the pipeline 100, when the movable body 10 passes through the bent portion 100b, for example, the movable body 10 is subjected to the attitude control so that the movable body 10 can pass through the bent portion 100b easily. The attitude control at that time is executed mainly such that the movable body 10 is rotated in the circumferential direction of the pipeline 100 inside the pipeline 100 and the attitude is changed or the like.

At this time, the other end portion of the cable 50 is fixed to the movable body fixing portion 10x of the movable body 10 as described above. As a result, a twist is generated in the cable 50 at the movable body fixing portion 10x as a start point with the rotation of the movable body 10 in the circumferential direction.

The cable 50 is configured by bundling the signal cable 50a for signal communication, the power supply cable 50b for power supply and the like as described above. Therefore, if a twist is generated in the cable 50, it is likely that the movement of the movable body 10 is prevented or the cable 50 itself is damaged. It is particularly likely the farther the movable body 10 is moved, the more the twist of the cable 50 is integrated.

Thus, in the embodiment, the twist of the cable 50 connected to the movable body 10 which is moving inside the pipeline 100 is detected by the twist detection portion 16. The detection result is outputted to the twist determination portion 15f of the control portion 15. As a result, the twist determination portion 15f determines the twist amount and the twist direction of the cable 50. And the judgement result of the twist determination portion 15f is outputted to the attitude control portion 15e as described above, and the attitude control portion 15e executes the attitude control in which the twist state of the cable 50 is modified and the twist is untwisted.

The attitude detection portion 17 is a circuit portion configured to detect the attitude of the movable body 10 which is moving inside the pipeline 100. The attitude detection portion 17 is configured by a well-known gyro sensor, for example, and the detection result of the attitude detection portion 17 is outputted to the attitude control portion 15e.

Note that in the movable body 10 with the configuration as above, an ultrasound search device or an X-ray image pickup device configured to obtain an ultrasound image and an X-ray image as inspection information can be provided as the inspection information obtaining portion besides the image pickup unit 11 configured to obtain an image as the inspection information.

The cable operating device 20 is, as illustrated in FIG. 2, configured mainly by a control portion 21, a cable rewinding mechanism 22, a display portion 23, an operation portion 24, a communication portion 28, a power supply portion 29 and the like.

The control portion 21 is including a control circuit and the like configured to integrally control the entirety of the cable operating device 20 and to control each of the configuration units at predetermined timing as appropriate.

The cable rewinding mechanism 22 is a configuration unit configured to enable automatic feeding operation or rewinding operation of the cable 50 corresponding to the reciprocating movement of the movable body 10 inside the pipeline 100.

For that purpose, the cable rewinding mechanism 22 is configured mainly by having a cable feeding detection portion 22a, a driving mechanism portion 22b, a driving motor 22c, a cable guide mechanism 26 and the like.

The cable feeding detection portion 22a is a circuit portion configured to detect a state of the cable 50 such as a fed-out amount of the cable 50 extended from the cable operating device 20. A detection result of the cable feeding detection portion 22a is outputted to the control portion 21. Upon receipt of the output, the control portion 21 executes required control as appropriate such as driving control of the driving motor 22c. As described above, a movement amount of the movable body 10 can also be calculated from the cable fed-out amount.

The driving mechanism portion 22b is a configuration unit including a rewinding drum portion 22d (see FIG. 1) configured to cause the cable 50 to be rewound, a driving force transmission mechanism (not shown) configured to transmit the driving force of the driving motor 22c to the rewinding drum portion 22d and the like. One end portion of the cable 50 is fixed to a predetermined part of the rewinding drum portion 22d. When the rewinding drum portion 22d is rotated forward/backward by the driving force of the driving motor 22c, the cable 50 is rewound around the rewinding drum portion 22d or is fed out.

The driving motor 22c is a driving source configured to drive the cable rewinding mechanism 22. The driving motor 22c is controlled by the control portion 21.

When the movable body 10 is moved forward inside the pipeline 100, for example, such control is executed that the driving motor 22c is rotated/driven in a predetermined direction, and the cable 50 is fed out of the rewinding drum portion 22d. On the other hand, when the movable body 10 is moved backward inside the pipeline 100, such control is executed that the driving motor 22c is rotated/driven in a predetermined direction, and the cable 50 is rewound around the rewinding drum portion 22d.

The cable guide mechanism 26 is a configuration unit configured to guide the cable 50 extended from the cable rewinding mechanism 22 when the movable body 10 is moved inside the pipeline 100. The cable guide mechanism 26 is configured by having a guide portion 26a having an insertion hole (not shown) into which the cable 50 is inserted/arranged. When the cable 50 is inserted into the insertion hole (not shown) of the guide portion 26a, the cable 50 is arranged movably in the longitudinal axis direction and rotatably in the circumferential direction.

Therefore, in a state where the cable 50 is inserted into the insertion hole (not shown) of the guide portion 26a, when the rewinding drum portion 22d is driven by the driving force of the driving motor 22c, and the cable 50 is fed out or rewound, the cable 50 slides inside the insertion hole (not shown) of the guide portion 26a in the longitudinal axis direction. Thus, an inner periphery of the insertion hole of the guide portion 26a is coated with a low friction material such as polytetrafluoroethylene (PTFB) in order to lower sliding friction.

The display portion 23 is controlled by the control portion 21. The display portion 23 is a configuration unit including a display panel configured to display various types of information. In the embodiment, a detection result of the cable feeding detection portion 22a is mainly displayed on the display portion 23, for example.

The operation portion 24 is an input device configured to receive an operation of a user and to receive an input of an instruction signal to the control portion 21. For the operation portion 24, a keyboard, a mouse, a touch panel, and a glove which detects an operation of a finger which will be described later are applied, for example.

The communication portion 28 is a configuration unit including a function of conducting mutual communication between each of the movable body 10 and the control device 30. The communication portion 28 is controlled by the control portion 21. The communication portion 28 and the communication portion 18 of the movable body 10 as well as the communication portion 28 and a communication portion 37 of the control device 30 are connected to each other by the signal cable 50a included in the cable 50.

As a result, the control portion 21 of the cable operating device 20 conducts transmission/reception of various signals such as reception of a predetermined control signal from the control device 30 through the communication portion 28, transmission of the received control signal to the movable body 10, reception of various types of data and various sensor outputs from the movable body 10, and transmission of the various signals received from the movable body 10 to the control device 30.

As a form of the communication portion 28, various forms such as wireless communication or wired communication can be applied similarly to the communication portion 18 of the movable body 10. In the embodiment, a form in which the wired communication with the movable body 10 is conducted using the signal cable 50a included in the cable 50 is exemplified.

Note that the configuration of the communication portion 28 only needs to include a communication function conducted between conventional electronic instruments, and those having been practiced in general can be applied. Therefore, detailed description and illustration are omitted.

The power supply portion 29 is a configuration unit configured to supply electricity to the entire cable operating device 20 and to supply electricity to the movable body 10 through the power supply cable 50b included in the cable 50. The power supply portion 29 is controlled by the control portion 21. For the power supply portion 29, a charging type battery or the like is applied and in addition, power supply from an external power source (or an external power supply through the control device 30) is received so that power is supplied to each circuit portion of each unit in the cable operating device 20 and the movable body 10 as necessary.

The control device 30 is provided integrally with the cable operating device 20, and integrally controls the entire in-pipe inspection system 1. The control device 30 includes a control portion 31, a display portion 32, an operation portion 33, a positioning portion 34, a communication portion 37, a storage portion 38, a power supply portion 39 and the like.

The control portion 31 is a control unit in a general form including a control circuit configured to integrally control the entire in-pipe inspection system 1 and application software and the like.

The display portion 32 is a configuration unit including a display panel configured to display various types of information. The display portion 32 is controlled by the control portion 31 and is capable of displaying the inspection information such as a movie picked up by the image pickup unit 11 of the movable body 10 on a real time basis, for example. The detection result or the like detected by the cable feeding detection portion 22a of the cable operating device 20 can be displayed on the display portion 32 instead of the display portion 23.

The operation portion 33 is an input device configured to receive an operation of a user and to receive an input of an instruction signal to the control portion 31. A keyboard, a mouse, a touch panel, and a glove which detects an operation of a finger which will be described later are applied for the operation portion 33, for example. Note that the operation portion 33 is capable of an input of an instruction signal to the cable operating device 20, for example, besides the instruction signal to the control portion 31 and as a result, the cable operating device 20 can be operated by the control device 30 without operating the operation portion 24.

The positioning portion 34 is configured by a GPS (global positioning system) receiver configured to receive a radio wave from a GPS satellite 80 and to detect an absolute position coordinate (GPS absolute position information) such as a latitude, a longitude, and an altitude of the control device 30 (the cable operating device 20 in which the control device 30 is integrally provided). That is, the positioning portion 34 in the embodiment has a function as a GPS information obtaining portion configured to obtain the position where the movable body 10 which is the inspecting device is input into the pipeline 100 as the GPS absolute position information.

The communication portion 37 is a configuration unit including a function for conducting mutual communication between each of the cable operating device 20 and the movable body 10. The communication portion 37 is controlled by the control portion 31. The communication portion 37 and the communication portion 28 of the cable operating device 20 as well as the communication portion 37 and the communication portion 18 of the movable body 10 are connected by the signal cable 50a included in the cable 50, respectively.

As a result, the control portion 31 of the control device 30 receives the predetermined control signal, various types of data and the various sensor outputs from the cable operating device 20 and the movable body 10 through the communication portion 37 and transmits the various control signals in accordance with the received various signals to the cable operating device 20 and the movable body 10.

As a form of the communication portion 37, various forms such as wireless communication or wired communication can be applied similarly to the communication portion 18 of the movable body 10 and the cable operating device 20. In the embodiment, the form in which the wired communication is conducted using the signal cable 50a included in the cable 50 is exemplified.

Note that the configuration of the communication portion 37 only needs to include the communication function conducted between conventional electronic instruments, and those having been practiced in general can be applied. Therefore, detailed description and illustration are omitted.

Here, the communication portion 37 is capable of receiving the inspection information such as images picked up by the image pickup unit 11, for example. Moreover, the communication portion 37 can receive the attitude information or the like detected by the attitude detection portion 17 as the movement information indicating the moving direction of the movable body 10 and can receive the attitude information or the like as the movement information indicating the moving distance of the movable body 10 calculated from the rotation number of the wheel driving motor 14 detected by the rotation detection portion 14a and the like. That is, the communication portion 37 in the embodiment has a function as a receiving portion.

The storage portion 38 is capable of storing various types of information received by the communication portion 37 and various types of information calculated in the control portion 31. The storage portion 38 also stores piping maps of the pipeline 100 to be inspected and the map information on the ground as appropriate.

Here, the piping map has an absolute position coordinate of a plurality of inspection ports 106 provided in order to allow a middle of the pipeline 100 to communicate with the ground as position information of a reference facility, for example. The piping map also has arrangement information of a plurality of pipes 101 configuring the pipeline 100, arrangement information of a joint portion 102 which connects the pipe 101 and the pipe 101, arrangement information of a valve 103 provided in the pipe 101 and the like as the arrangement information of the pipeline 100 extending from the reference facility. Furthermore, the piping map has inspection section information which divides the pipeline 100 into a plurality of sections. Note that the section is set for convenience in order to manage the inspection of the pipeline 100, and each section is managed by being given a tag which indicates a section name of the section.

Each of the sections is set by the control portion 31, for example. That is, the control portion 31 basically divides the pipeline 100 into sections each having a length in a predetermined range (100 m±10 m, for example). However, the sections are set so that the joint portion 102 or the valve 103 does not exist on a boundary between sections, and the section includes the joint portion 102, the valve 103 or a bent portion of the pipe. That is, the control portion 31 corrects the length of each section so that the boundary is located at a position away from the joint portion 102, the valve 103 or the bent portion by a predetermined distance (50 cm to 1 m, for example) or more. Moreover, as will be described later, the control portion 31 re-sets each section as appropriate as necessary on a basis of conditions or the like set in advance.

The power supply portion 39 is a configuration unit which can supply electricity to the entire control device 30. The power supply portion 39 is controlled by the control portion 31. A charging type battery or the like is applied for the power supply portion 39 and in addition, power supply from an external power source is received so that power is supplied as necessary to each circuit portion of each unit in the control device 30.

Note that for the control device 30, a general-purpose small-sized computer practiced in general and application software which runs on the computer can be applied, for example. Therefore, detailed description of the configuration is omitted.

Here, in the embodiment, the control portion 31 of the control device 30 has a function as a pipeline inspection information managing device which generates the pipeline inspection information for inspecting deterioration, such as a crack in the pipeline, by executing the pipeline inspection information generation processing which will be described later in accordance with a program or the like set in advance.

That is, the control portion 31 specifies the position of the movable body 10 on the piping map on a real time basis based on the GPS absolute position information obtained by the positioning portion 34 and the movement information received from the movable body 10 through the communication portion 37. Moreover, the control portion 31 generates the management information which associates the inspection information (movie information and the like) currently received from the movable body 10 through the communication portion 37 with a current position of the movable body 10 specified on the piping map.

The management information is generated for each of the plurality of sections which divide the pipeline 100 on the piping map. That is, a plurality of the sections obtained by dividing the pipeline 100 into predetermined sections is set on the piping map, and the inspection information associated with the position on the piping map is stored as the management information in the storage portion 38 and the like with the same tag (section name) for each section together with the section information (a lot-number label including a start point, an end point and the like of the section) and supplementary information such as time and date of the inspection.

In this case, as illustrated in FIG. 6, for example, the boundary between each of the sections set in the pipeline 100 is set at a position away by a set distance (approximately 50 cm to 1 m, for example) or more from the joint portion 102 which connects the pipe 101 and the pipe 101 configuring the pipeline 100 and is set to include at least one joint portion 102. Moreover, the boundary between the sections set in the pipeline 100 is set at a position away by the set distance (approximately 50 cm to 1 m, for example) or more from the valve 103 provided in the pipeline 100. The movable body 10 cannot pass through the valve 103, and different inspection (gas leakage, water leakage inspection, for example) is conducted for the inspection of the valve 103. Therefore, with regard to the inspection information of the valve 103, information associated with the section including the valve 103 is managed. Since the valve 103 has the joint portions on both ends, the section including the valve 103 has at least two joint portions. That is, the boundary between each of the sections is set at a position which avoids the joint portion 102 and the valve 103.

Note that it is preferable that, for each of the sections set as above, basic tags (section names) such as a, b, c . . . are set for the sections on a main pipeline in the pipeline 100 and the tags (section names) such as b1-a, b1-b . . . derived from a basic tag are set for sections on a sub pipeline (branching pipeline) branching from the main pipeline in each section. By using an order of section names, an inspector can easily give an instruction when section information of a section adjacent to the section under inspection is to be called. Moreover, a section can be specified by instructing the first section name and the last section name in a case of section specification across several sections, and efficient inspection is realized.

In generation of such management information, the control portion 31 determines whether or not information corresponding to a scratch 105 exists in the pipeline 100 on a basis of the inspection information currently received from the movable body 10. The judgement of the scratch 105 is made by well-known image analysis or the like.

When it is expected from the information relating to the scratch 105 that the scratch 105 lies across adjacent 2 sections, that is, if the scratch 105 lies within a predetermined distance (within 50 cm to 1 m, for example) with respect to the boundary between the consecutive sections, the control portion 31 sets a section given a new tag (section name) by extending or reducing the currently set section so that the scratch 105 is located in one section reliably and generates the management information for the new section.

That is, as illustrated in FIGS. 6 and 7, for example, if a scratch 105 exists closer to an end point (boundary) of the section with the tag a (section a) and it is expected that the scratch 105 lies across the two sections, the control portion 31 extends an end part of the section a to a side of a section given a tag b (section b). As a result, the control portion 31 sets a new section (section a′) given a new tag a′, and the management information is generated for the section a′. Note that with setting of the section a′, the section b is reduced and thus, the reduced section becomes a new section (section b′) given a new tag b′.

Alternatively, as illustrated in FIGS. 6 and 8, for example, if the scratch 105 is expected to exist on the end point (boundary) of the section a, the control portion 31 connects the section a and the section b and sets a new section (section ab) given a tag ab with a new section name. Then, the control portion 31 generates the management information on the section ab.

Further, the control portion 31 generates a pipeline map which associates the pipeline position with the section information on the map on a basis of the GPS absolute position information, the piping map, and map information on the ground.

Note that the management information of each section generated as above, the pipeline map and the like can be transmitted through the communication portion 37 to the data processing device 60 and the portable terminal device 70 and the like which will be described later.

As described above, in the embodiment, the control portion 31 has respective functions of the position specifying portion, the information associating portion, the judgement portion, and the pipeline map generation portion. Note that the functions of the position specifying portion, the information associating portion, the judgement portion, and the pipeline map generation portion can also be realized in the control portion 21 of the cable operating device 20 instead of the control portion 31 of the control device 30.

The management information and the pipeline map and the like generated in the control portion 31 as above can be displayed on the display portion 32 and the like.

More specifically, as illustrated in FIG. 9, for example, a movie recorded in association with the position of the movable body 10 in the pipeline 100 is displayed together with the predetermined supplementary information, and the pipeline map indicating the section corresponding to the currently displayed movie, the position of the movable body 10 and the like can be displayed. Moreover, as illustrated in FIG. 10, for example, the current management information and the past management information can be displayed in parallel after synchronization. In the case of FIG. 10, a section end portion which did not have a scratch or the like in the past is now found to have a scratch or the like in the current inspection, the past section name has been changed to the current section name as described above, and the displayed two section names are different. Since the inspection data or the like is associated with the section name, recorded inspection data can be displayed from the displayed section name.

The data processing device 60 is installed in a data processing center 61, for example. The data processing device 60 is configured by including a storage portion 60a with a large capacity.

The data processing device 60 can make an access to the cable operating device 20 and the control device 30 through an internet line, wireless communication and the like.

As a result, the data processing device 60 can receive the pipeline map, the management information of each of the sections generated in the control device 30 and the like and store the management information and the pipeline map and the like in the storage portion 60a. Note that the pieces of the management information and the like are managed according to the tags and recorded for each section and each time and date when the data was obtained, for example.

The data processing device 60 can also receive the inspection information and the like obtained by the movable body 10 as necessary, give a predetermined tag and temporarily store the inspection information and the like as raw information in the storage portion 60a.

Moreover, the data processing device 60 can read out the management information and the like of a desired section and the time and date when the data was obtained from various types of data stored in the storage portion 60a and transmit the management information and the like to the control device 30, the portable terminal device 70 and the like.

The portable terminal device 70 is configured by a well-known tablet type terminal device, for example. The portable terminal device 70 can make an access to the control device 30 and the data processing device 60 through the internet line, the wireless communication and the like.

As a result, reception of the management information of each of the sections, the pipeline map and the like from the control device 30 and the data processing device 60 and display on the display portion (not shown) can be realized.

Here, the portable terminal device 70 can be configured by a wearable-type terminal device, instead of the tablet type terminal device, as an interface for carrying out an operation and display accurately between the user (wearer) and the inspecting device.

In this case, the portable terminal device 70 is configured mainly by having the operation portion and the display portion. That is, the wearable portable terminal device 70 is configured by having a glove-type first wearable portion 71 as the operation portion to be worn on the hand of the user, an operating device 72 as the operation portion gripped by the hand of the user who wears the first wearable portion 71, a wrist-band type second wearable portion 73 worn on the wrist of the user, and a glasses-type third wearable portion 74 as the display portion worn on the head part of the user as illustrated in FIG. 4, for example.

The first wearable portion 71 is configured by having a first wearable body 71a having a glove shape and a pressure sensor 71b and a bending sensor 71c mounted on the first wearable body 71a.

The pressure sensor 71b and the bending sensor 71c are configured by a piezoelectric element, a piezoelectric fiber and the like. When a voltage is generated in accordance with movement of a finger of the user who wears the first wearable portion 71 and a voltage signal generated by the movement of the hand which grips the operating device 72 is transmitted to the operating device 72, the operating device 72 is turned on, and the pressure sensor 71b and the bending sensor 71c transmit, to the operating device 72, the voltage signal generated in accordance with a pressed amount and a bent amount after the operating device 72 is turned on. The operating device 72 converts the voltage signal to an operation signal, displays and transmits the operation signal to an operation information processing device 72b.

The operating device 72 is configured by having an operating device body 72a having a shape which can be gripped by the user, the operation information processing device 72b built in the operating device body 72a, and a display portion 72c.

When the operation information processing device 72b receives the operation signal transmitted from the first wearable portion 71, the operation information processing device 72b determines a command or the like assigned to the received operation signal and transmits the judgement result to the second wearable portion 73. The operation information processing device 72b can also receive the operation signal from an operation portion 75 or the like other than the first wearable portion 71 and when the operation information processing device 72b receives the operation signal transmitted from the operation portion 75 or the like, the operation information processing device 72b determines the command or the like assigned to the received operation signal and transmits the judgement result to the second wearable portion 73.

Moreover, the operation information processing device 72b receives the radio wave from the GPS satellite 80, detects the absolute coordinate such as the latitude, the longitude, and the altitude of the user, and transmits the detected absolute coordinate to the second wearable portion 73.

Furthermore, the operation information processing device 72b receives the management information stored in the data processing device 60, the pipeline map and the like and transmits the received management information, the pipeline map and the like to the second wearable portion 73 in accordance with a predetermined command and the like.

The display portion 72c can display various types of information in accordance with the control signal from the operation information processing device 72b. For example, the display portion 72c can display virtual switches indicating various commands at positions associated with the movement of the hand of the user who grips the operating device body 72a. Alternatively, the display portion 72c can display information similar to the information displayed on a third wearable portion 74 which will be described later.

The second wearable portion 73 is configured by having a second wearable body 73a having a wrist-band shape and a work information processing device 73b built in the second wearable body 73a.

The work information processing device 73b executes various types of information processing on the various commands, the absolute position, the management information, the pipeline map and the like received from the operating device 72. For example, the work information processing device 73b can generate, on a basis of the pipeline map and the like, a three-dimensional image of the pipeline 100 based on the absolute coordinate detected by the operation information processing device 72b.

The work information processing device 73b also transmits the various commands, the management information and the like received from the operating device 72 to the third wearable portion 74 as appropriate and transmits the generated three-dimensional image of the pipeline 100 and the like to the third wearable portion 74.

The third wearable portion 74 is configured by having a third wearable body 74a having a shape of glasses, an image pickup unit 74b attached to the third wearable body 74a, an image display 74c, and a transmission information processing device 74d.

The image pickup unit 74b is fixed to the third wearable body 74a in a state where an image pickup optical axis is in the direction which substantially matches a visual line of the user.

The image display 74c is configured by a retina scanning display or the like capable of displaying information superposed on a scene actually seen by the user, for example, and can display various types of display information generated in the transmission information processing device 74d.

The transmission information processing device 74d executes processing for displaying the various types of information on the image display 74c in a predetermined display form in accordance with the command or the like received from the second wearable portion 73.

For example, the transmission information processing device 74d calculates a distance from the image pickup unit 74b to the ground and a depression angle of the image pickup optical axis of the image pickup unit 74b to the ground by well-known image processing and the like based on the image picked up by the image pickup unit 74b. Then, the transmission information processing device 74d can display the information of the pipeline 100 and the like existing in the ground in association with the ground in an actual space on the image display 74c by changing the form, the position and the like of the pipeline on the pipeline map in accordance with the calculation results.

Subsequently, pipeline inspection information generation processing executed in the control portion 31 of the aforementioned control device 30 will be described in accordance with a flowchart of a pipeline inspection information generation processing routine illustrated in FIG. 5.

When the routine is started, the control portion 31 first makes initial setting at Step S101.

That is, the control portion 31 sets an initial position and an attitude of the movable body 10 on a basis of the GPS absolute position information and the like of the cable operating device 20 arranged at the inspection port 106 of the pipeline 100 which is a reference facility, for example.

The control portion 31 also sets an inspection range in the pipeline 100. Here, setting of the inspection range in the pipeline 100 is made by selecting any one of the tags of the sections currently set on the pipeline 100, respectively, on a basis of an operation input by the user into the operation portion 24 or the like. That is, when any one of the tags of the respective sections on the pipeline 100 is selected by the user, the control portion 31 sets a point before the start point of the section by a set distance (50 cm to 1 m, for example) corresponding to the selected tag as an inspection start position and sets a point after the end point of the section by a set distance (50 cm to 1 m, for example) as an inspection end position. At this time, if the inspection distance (the distance from the input position of the movable body 10 into the pipe to the inspection end position) exceeds a movement limit of the movable body 10, an alarm is displayed on the display portion 23, and setting is not made.

When the routine proceeds to Step S102, the control portion 31 carries out detection on whether or not the cable operating device 20 and the movable body 10 are connected to the control device 30.

That is, the control portion 31 makes detection on whether or not the cable operating device 20 and the movable body 10 are connected to the control device 30 by examining whether communication with the control portion 15 of the movable body 10 is established or not. If the communication with the control portion 15 of the movable body 10 is not established, the control portion 31 specifies whether an instrument not connected to the control device 30 is only the movable body 10 or both the cable operating device 20 and the movable body 10 by examining whether the communication with the control portion 21 of the cable operating device 20 is established or not, for example.

At a subsequent Step S103, the control portion 31 examines whether or not an operation start signal has been turned ON. Here, the operation start signal is a signal which is turned ON when the initial setting has been completed at the aforementioned Step S101 and it is detected at the aforementioned Step S102 that the control device 30 is connected to the cable operating device 20 and the movable body 10.

Then, when the control portion 31 determines that the operation start signal is turned OFF at Step S103, the routine returns to Step S101, while if it is determined that the operation start signal is turned ON, the routine proceeds to Step S104.

When the routine proceeds from Step S103 to Step S104, the control portion 31 executes operation control to various actuators of the movable body 10 and the cable operating device 20 so as to execute control of moving the movable body 10 to the inspection start position in the pipeline 100. That is, the control portion 31 executes movement (advance) control of the movable body 10 in the pipeline 100 by executing operation control of the wheel driving motor 14 and the like of the movable body 10 through an instruction to the control portion 15 and the control portion 21 and executes feeding-out control of the cable 50 in conjunction with the movement of the movable body 10 by executing operation control of the driving motor 22c of the cable operating device 20 and the like.

At the subsequent Step S105, the control portion 31 detects the current position of the movable body 10 in the pipeline 100 on a basis of the initial position of the movable body 10 set at Step S101, the rotation number of the wheel driving motor 14 detected by the rotation detection portion 14a of the movable body 10, the attitude information of the movable body 10 detected by the attitude detection portion 17 and the like.

Then, when the routine proceeds to Step S106, the control portion 31 examines whether or not the movable body 10 has reached the inspection start position in the pipeline 100 on a basis of the current position detected at Step S105.

Then, if it is determined at Step S106 that the movable body 10 has not reached the inspection start position, the control portion 31 returns to Step S104. Note that even during the movement of the movable body 10 before reaching such inspection start position, the control portion 31 obtains the inspection information in the pipeline 100 as reference data by driving the inspection information obtaining portion such as the image pickup unit 11 and can give an alarm or the like if nonconformity in the pipeline 100 is detected on a basis of the reference data.

On the other hand, if it is determined at Step S106 that the movable body 10 has reached the inspection start position, the control portion 31 proceeds to Step S107 and conducts the inspection in the pipeline 100 for the inspection range set at present.

That is, the control portion 31 obtains the movie and the like in the pipeline 100 as the inspection information by driving the inspection information obtaining portion such as the image pickup unit 11 through the instruction to the control portion 15. Then, the control portion 31 specifies the position of the corresponding movable body 10 on the piping map on a basis of the current position detected at Step S105 and generates the management information by associating the specified position on the piping map with the current inspection information. Further, the control portion 31 conducts the inspection on whether or not a problem such as the scratch 105 exists in the pipeline 100 by executing image processing or the like based on the obtained inspection information. Note that the inspection at Step S107 includes the operation of the movable body 10 and is basically conducted while the movable body 10 is being moved. However, if a scratch or the like is found, the movable body 10 is stopped at that spot, and the inspection information obtaining portion or the like can be controlled so that detailed inspection information at the spot is obtained.

When the routine proceeds from Step S107 to Step S108, the control portion 31 examines whether or not the movable body 10 has reached the inspection end position in the pipeline 100 on a basis of the current position detected at Step S105.

Then, at Step S108, if it is determined that the movable body 10 has not reached the inspection end position, the control portion 31 returns to Step S107 and continues an inspection operation.

On the other hand, if it is determined at Step S108 that the movable body 10 has reached the inspection end position, the control portion 31 proceeds to Step S109 and examines whether or not a problem such as the scratch 105 has been detected in the pipeline 100 near the inspection end position. Note that the detection of the problem may be made not by detection by an image but by other detectors (an ultrasound inspecting machine, an X-ray inspecting machine and the like) not described herein.

Then, if it is determined at Step S109 that a problem has been detected in the pipeline 100 near the inspection end position, the control portion 31 proceeds to Step S110 and changes the currently set inspection end position and then, changes the section range and the section name at Step S111, returns to Step S107 and continues the inspection operation.

That is, the control portion 31 sets a new section extended from the currently selected section, re-sets the inspection end position on a basis of the end part of the new section, and changes the section name That is, the control portion 31 sets the new section by extending the end part of the currently selected section to the adjacent section side (see FIGS. 6 and 7) or by connecting the currently selected section and the adjacent section (see FIGS. 6 and 8) and sets the inspection end position on a basis of the end part of the new section. As a result, the inspection end position is changed to a position away from the position where the problem such as the scratch 105 is detected. Note that the management information relating to the section before the new section is set is managed as the management information of the new section by using the new section name.

On the other hand, if it is determined at Step S109 that no problem is detected in the pipeline 100 near the inspection end position, the control portion 31 proceeds to Step S112, carries out the inspection end operation and then, exits the routine.

That is, the control portion 31 stops driving of the inspection information obtaining portion such as the image pickup unit 11 through the instruction to the control portion 15. Then, the control portion 31 executes movement (retreat) control of the movable body 10 in the pipeline 100 by driving control of the wheel driving motor 14 or the like of the movable body 10, executes rewinding control of the cable 50 in conjunction with the movement of the movable body 10 by driving control of the driving motor 22c or the like of the cable operating device 20, and returns the movable body 10 to the movable body input position through the instruction to the control portion 15 and the control portion 21.

According to the embodiment as above, the position where the movable body 10 is input into the pipeline 100 is obtained as the GPS absolute position information in the positioning portion 34, the movement information relating to the movement state of the movable body 10 and the inspection information obtained by the movable body 10 are received in the communication portion 37, the position of the movable body 10 on the piping map, that is, the position of the joint portion 102 and the position of the detected problem such as a scratch are specified in the control portion 31 on a basis of the GPS absolute position information and the movement information, and the pipeline inspection information associated with the specified position on the piping map and the inspection information from the movable body 10 is generated and managed for each section set on the piping map so that at least one joint portion 102 which connects the pipe 101 and the pipe 101 configuring the pipeline 100 is included so that deterioration such as a crack generated in the pipeline 100 can be inspected efficiently and accurately.

That is, the pipeline 100 such as a water pipe and a gas pipe buried in the ground or the like is laid for a long distance, but by considering that the scratch 105 such as a crack in the pipeline 100 is generated generally at the joint portion 102 in the pipe 101 easily, a plurality of the sections is set on the pipeline 100 so that at least one joint portion is included, and the pipeline inspection information is managed for each of the sections so that the same scratch 105 can be managed in one section and listed and the deterioration such as a crack can be inspected efficiently. At that time, the position of the scratch 105 or the like is measured with the movable body input position measured by the GPS with high accuracy as the start point and thus, position accuracy is improved.

If it is determined whether or not the scratch 105 such as a crack exists in the pipeline 100 on a basis of the inspection information, it is determined that the information corresponding to the scratch 105 exists in the pipeline 100, and it is specified that the scratch 105 lies within a predetermined distance with respect to the boundary of the consecutive sections, the section is re-set so that the boundary of the sections is located at a position away from the scratch 105 by a set distance or more, and by managing the management information in association with the new section, deterioration such as a crack generated in the pipeline 100 can be inspected efficiently even if the scratch 105 is generated at a place other than the joint portion 102 of the pipe 101.

The present invention is not limited to the aforementioned embodiment, but naturally various variations and application can be practiced within a range not departing from the gist of the invention. Moreover, the aforementioned embodiment includes the invention in various stages, and the various inventions can be extracted by appropriate combinations of a plurality of disclosed constituent elements. For example, even if some constituent elements are deleted from all the constituent elements illustrated in the aforementioned embodiment, in a case where the problems to be solved by the invention can be solved and the advantageous effect of the invention can be obtained, the configuration from which the constituent element was deleted can be extracted as the invention. Moreover, the constituent elements across the different embodiments may be combined as appropriate. The invention is not limited by the specific embodiment except that the invention is limited by the appended claims.

Here, each of the devices and the control portion and the like included in the devices illustrated in the aforementioned embodiment may be realized by a computer including one or a plurality of processors, logical circuits, memories, input/output interfaces, computer-readable recording medium and the like. In that case, the realization may be made by recording a program configured to realize the functions of each constituent element or the entire body portion in the recording medium and by causing the recorded program to be read by a computer system and to be executed. For example, the processor is at least any one of a CPU (central processing unit), a DSP (digital signal processor), and a GPU (graphics processing unit). For example, the logical circuit is at least either one of an ASIC (application specific integrated circuit) and an FPGA (field-programmable gate array).

What is claimed is:

1. A pipeline inspection information managing device comprising:
a GPS information obtaining portion configured to obtain a position where an inspecting device is input into a pipeline as GPS absolute position information;
a receiving portion configured to receive movement information relating to a movement state of the inspecting device and inspection information of the inspecting device;
a position specifying portion configured to specify a position of the inspecting device on a piping map on a basis of the GPS absolute position information and the movement information; and
an information associating portion configured to generate pipeline inspection information which associates the position of the inspecting device specified by the position specifying portion on the piping map with the inspection information from the inspecting device for a section set on the piping map, wherein
each of the sections is set to include at least one joint portion which connects a pipe and a pipe configuring the pipeline.

2. The pipeline inspection information managing device according to claim 1, further comprising:
a determination portion configured to determine whether information corresponding to a scratch exists in a pipe on a basis of the inspection information from the receiving portion, wherein
when the determination portion determines that the information corresponding to the scratch exists in the pipe and the position specifying portion specifies that the inspecting device is located within a predetermined distance with respect to a boundary between consecutive sections, the information associating portion generates a section including a new section name by making the consecutive sections into one section and associates the inspection information from the inspecting device with the section with the new section name.

3. The pipeline inspection information managing device according to claim 1, further comprising:
a storage portion including position information of a reference facility including an absolute position coordinate, arrangement information of a pipeline extending from the reference facility, section information in which the pipeline is divided into the plurality of sections on a basis of the absolute position coordinate and the arrangement information of the pipeline, and map information on a ground; and
a pipeline map generation portion configured to generate a pipeline map in which a pipeline position and section information are associated on the map on a basis of the GPS absolute position information, the arrangement information of the pipeline, the section information, and the map information.

4. The pipeline inspection information managing device according to claim 1, wherein
the inspecting device includes an image pickup device, and the inspection information is movie information; and
the position specifying portion specifies whether the inspecting device is located within a predetermined distance with respect to a boundary between consecutive sections on a basis of the movie information.

5. The pipeline inspection information managing device according to claim 1, wherein
the information associating portion generates a section including a new section name by making the consecutive sections into one section and associates the inspection information from the inspecting device with the section including the new section name besides the section set in advance.

6. A pipeline inspection information managing method, comprising:
obtaining a position where an inspecting device is input into a pipeline as GPS absolute position information;
receiving movement information relating to a movement state of the inspecting device and inspection information of the inspecting device;
specifying a position of the inspecting device on a piping map on a basis of the GPS absolute position information and the movement information; and
generating and managing pipeline inspection information which associates the position specified on the piping map with the inspection information from the inspecting device for each of the sections set on the piping map so that at least one joint portion which connects a pipe and a pipe configuring the pipeline is included.
